(19) United States
(12) Patent Application Publication
(10) Pub. No.: US 2025/0324028 A1
(43) Pub. Date: Oct. 16, 2025

(54) METHOD FOR PROVIDING VIDEO COMMUNICATION SERVICE USING GENERATIVE AI AND APPARATUS THEREOF

(71) Applicant: SAMSUNG SDS CO., LTD., Seoul (KR)

(72) Inventors: Hyunil KIM, Seoul (KR); Heetae YOON, Seoul (KR); Junho KANG, Seoul (KR); Youngjin KIM, Seoul (KR); Hosung AHN, Seoul (KR)

(73) Assignee: SAMSUNG SDS CO., LTD., Seoul (KR)

(21) Appl. No.: 19/176,034

(22) Filed: Apr. 10, 2025

(30) Foreign Application Priority Data
Apr. 12, 2024 (KR) 10-2024-0049038
May 29, 2024 (KR) 10-2024-0070274

(51) Int. Cl. H04N 17/04

(52) U.S. Cl. CPC H04N 17/04

(57) ABSTRACT

The present disclosure relates to a method for providing guidance information related to a video communication service, and the method includes obtaining at least one of network quality data and media quality data related to video communication; determining whether quality of the video communication deteriorates, based on the obtained at least one of the network quality data and the media quality data; generating first guidance information for solving a deterioration in the quality of the video communication, based on a first prompt using a generative AI model when the quality of the video communication deteriorates; and generating second guidance information for sharing the deterioration in the quality of the video communication, based on a second prompt using the generative AI model when the quality of the video communication deteriorates.

### CROSS-REFERENCE TO RELATED APPLICATIONS

This application claims priority to Korean Patent Application No. 10-2024-0049038 filed on Apr. 12, 2024 and Korean Patent Application No. 10-2024-0070274 filed on May 29, 2024, in the Korean Intellectual Property Office, the entire contents of which are hereby incorporated by reference in its entirety.

### BACKGROUND OF THE INVENTION

### 1. Field of the Invention

The present disclosure relates to a technology for providing a video communication service and, more particularly, to a method for providing guidance information related to a video communication service by using a generative AI model and an apparatus thereof.

### 2. Description of the Prior Art

A video communication system includes a plurality of user terminals performing video communication and a server relaying data transmission/reception between the plurality of user terminals. Each user terminal transmits media data (i.e., image/audio data) to the server, and the server transmits the received media data to another user terminal.

When real-time video communication is performed through the video communication system, a network of a user terminal transmitting the medial data may be unstable to cause deterioration in the quality of the video communication. However, when a video communication quality deterioration event occurs, the existing video communication system provides no separate action guidance or situation sharing guidance to the user terminals. Accordingly, a user transmitting the media data may not know how to take an appropriate action even in a situation in which an appropriate action is possible, and thus the video communication may not be smooth. A user receiving the media data may be engaged in checking the physical environment thereof without recognizing there is a problem with the transmitting terminal, and thus the video communication may not be smooth. Therefore, a method is needed to stably conduct real-time video communication when a quality deterioration event occurs due to network instability or the like.

### SUMMARY OF THE INVENTION

The present disclosure has been made in order to solve the above-mentioned problems and other problems. An aspect of the present disclosure is to provide a method for generating and providing action guidance information for resolving video communication quality deterioration, based on a generative AI mode, and an apparatus therefor.

Another aspect of the present disclosure is to provide a method for generating and providing situation guidance information for sharing occurrence of a video communication quality deterioration event in a transmitting terminal, based on a generative AI mode, and an apparatus therefor.

To achieve the foregoing or other aspects, an embodiment of the present disclosure provides a guidance information providing method including: obtaining at least one of network quality data and media quality data related to video communication; determining whether quality of the video communication deteriorates, based on the obtained at least one of the network quality data and the media quality data; and generating first guidance information for solving a deterioration in the quality of the video communication, based on a first prompt using a generative AI model when the quality of the video communication deteriorates.

Another aspect of the present disclosure provides a guidance information providing server including at least one processor executing a plurality of instructions to perform a plurality of operations and at least one memory storing the plurality of instructions, wherein the plurality of operations includes: obtaining at least one of network quality data and media quality data related to video communication; determining whether quality of the video communication deteriorates, based on the obtained at least one of the network quality data and the media quality data; and generating first guidance information for solving a deterioration in the quality of the video communication, based on a first prompt using a generative AI model when the quality of the video communication deteriorates.

Still another aspect of the present disclosure provides a computer-readable storage medium storing one or more programs for execution by one or more processors of a computing device, the one or more programs including instructions to: obtain at least one of network quality data and media quality data related to video communication; determine whether quality of the video communication deteriorates, based on the obtained at least one of the network quality data and the media quality data; and generate first guidance information for solving a deterioration in the quality of the video communication, based on a first prompt using a generative AI model when the quality of the video communication deteriorates.

### BRIEF DESCRIPTION OF THE DRAWINGS

The accompanying drawings are included as a part of the detailed description to help the understanding of the present disclosure, and illustrate embodiments and the technical features of the present disclosure in conjunction with the detailed description, in which:

FIG. 1 illustrates the configuration of a video communication system according to an embodiment of the present disclosure;

FIG. 2 is a block diagram illustrating the configuration of a user terminal according to an embodiment of the present disclosure;

FIG. 3 is a diagram referenced to explain the operation of a network quality measurement unit;

FIG. 4 is a diagram referenced to explain the operation of a media codec unit;

FIG. 5 is a diagram referenced to explain the operation of a prompt generation unit;

FIGS. 6A and 6B illustrate first and second prompts to be input to a generative AI model;

FIG. 7 is a block diagram illustrating the configuration of an AI server according to an embodiment of the present disclosure;

FIGS. 8A and 8B illustrate action guidance information and situation guidance information;

FIG. 9 illustrates a method referenced to explain a method in which an AI server generates action guidance information and provides the action guidance information to a transmitting terminal;

FIG. 10 illustrates a method referenced to explain a method in which an AI server generates situation guidance information and provides the situation guidance information to a receiving terminal;

FIG. 11 is a flowchart illustrating a guidance information providing method according to an embodiment of the present disclosure; and

FIG. 12 is a block diagram illustrating the configuration of a computing device according to an embodiment of the present disclosure.

### DETAILED DESCRIPTION OF THE EXEMPLARY EMBODIMENTS

Hereinafter, embodiments disclosed herein will be described in detail with reference to the accompanying drawings, in which like or similar elements are denoted by like reference numerals regardless of drawing numerals and redundant descriptions thereof will be omitted. As used herein, the terms “module” and “unit” for components are given or interchangeably used only for ease in writing the specification and do not themselves have distinct meanings or functions. That is, the term “unit” used herein refers to software or a hardware component, such as FPGA or ASIC, and a “unit” performs certain functions. However, a “unit” is not limited to software or hardware. A “unit” may be configured to be in an addressable storage medium or may be configured to play one or more processors. Thus, in one example, a “unit” includes components, such as software components, object-oriented software components, class components, and task components, processes, functions, properties, procedures, subroutines, segments of a program code, drivers, firmware, a microcode, circuitry, data, a database, data structures, tables, arrays, and variables. Functions provided in components and “units” may be combined into a smaller number of components and “units” or may be further divided into additional components and “units”.

When detailed descriptions about related known technology are determined to make the gist of embodiments disclosed herein unclear in describing the embodiments disclosed herein, the detailed descriptions will be omitted herein. In addition, it should be understood that the accompanying drawings are only for easy understanding of the embodiments disclosed herein, and technical ideas disclosed herein are not limited by the accompanying drawings but include all modifications, equivalents, or substitutes included in the spirit and technical scope of the disclosure.

The present disclosure proposes a method for generating and providing action guidance information for solving deterioration in video communication quality, based on a generative AI model and an apparatus therefor. Further, the present disclosure proposes a method for generating and providing situation guidance information for sharing occurrence of a video communication quality deterioration event to a transmitting terminal, based on a generative AI model and an apparatus therefor. Hereinafter, in this specification, a transmitting terminal refers to a user terminal transmitting media data, and a receiving terminal refers to a user terminal receiving the media data.

Hereinafter, various embodiments of the present disclosure will be described in detail with reference to the drawings.

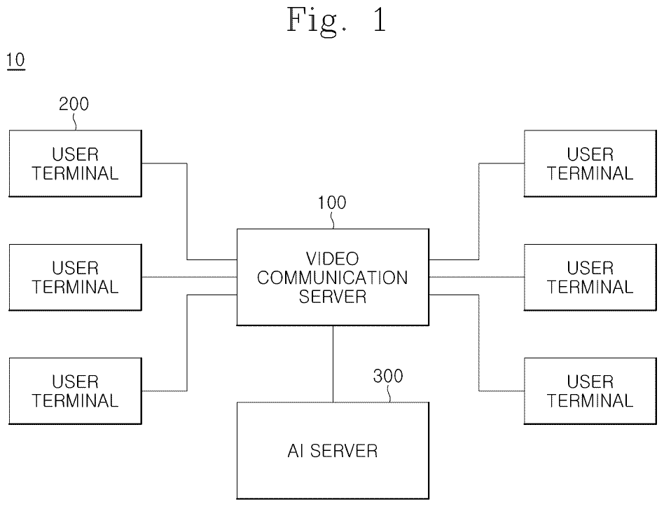

FIG. 1 illustrates the configuration of a video communication system according to an embodiment of the present disclosure.

Referring to FIG. 1, a video communication system 10 according to the embodiment of the present disclosure may include a video communication server 100, a plurality of user terminals 200, and an AI server 300.

The video communication server 100, the plurality of user terminals 200, and the AI server 300 may be connected to each other through a communication network (not shown). The communication network may include a wired network and a wireless network, and may include specifically various networks, such as a local area network (LAN), a metropolitan area network (MAN), and a wide area network (WAN). However, the communication network according to the present disclosure is not limited to the networks listed above, and may include at least one of a known wireless data network, a known telephone network, and a known wired/wireless television network.

The video communication server 100 may provide a video communication service for the plurality of user terminals 200. The video communication service may include a video conferencing service, a video call service, a video chat service, and the like, but is not necessarily limited thereto. Hereinafter, in the present embodiment, for convenience of explanation, the video conferencing service is illustrated as the video communication service.

The video communication server 100 may relay data transmission/reception between the plurality of user terminals 200. That is, the video communication server 100 may receive media data (e.g., video/audio data) from a specific user terminal, and may transmit the received media data to other user terminals.

A user terminal 200 may provide a video communication service received from the video communication server 100 to a user. The user terminal 200 may download and install an application (or program) for providing the video communication service. The user terminal 200 may access App Store, Play Store, a website, and the like to download the application, or may download the application through a separate storage medium.

The user terminal 200 may provide the user with guidance information received from the AI server 300 when a video communication quality deterioration event occurs due to network instability or the like. The guidance information may include action guidance information for solving video communication quality deterioration and situation guidance information for sharing occurrence of the video communication quality deterioration event with a transmitting terminal.

The user terminal 200 described herein may include a mobile phone, a smartphone, a laptop computer, a desktop computer, a digital broadcasting terminal, a personal digital assistant (PDA), a portable multimedia player (PMP), a slate PC, a tablet PC, an ultrabook, and a wearable device, but is not necessarily limited thereto.

The AI server (or guidance information providing server) 300 may generate action guidance information and situation guidance information by using a generative AI model. The generative AI model is a type of large language model (LLM), and may employ Chat-GPT or Bard but is not necessarily limited thereto.

The AI server 300 may provide action guidance information to a user terminal that transmits media data (hereinafter, referred to as a “transmitting terminal”). In addition, the AI server 300 may provide situation guidance information to a user terminal that receives media data (hereinafter, referred to as a “receiving terminal”).

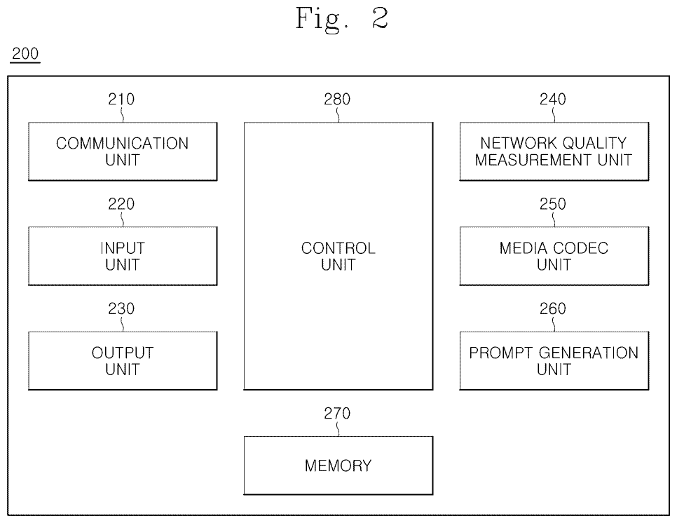

FIG. 2 is a block diagram illustrating the configuration of a user terminal according to an embodiment of the present disclosure.

Referring to FIG. 2, the user terminal 200 according to the embodiment of the present disclosure may include a communication unit 210, an input unit 220, an output unit 230, a network quality measurement unit 240, a media codec unit 250, a prompt generation unit 260, a memory 270, and a control unit 280. The components illustrated in FIG. 2 are not essential to configure the user terminal, and thus the user terminal described herein may have more or fewer components than the components listed above.

The communication unit 210 may include a wired communication module for supporting a wired network and a wireless communication module for supporting a wireless network. The wired communication module transmits and receives a wired signal to and from at least one of an external server and other terminals via a wired communication network established according to technical standards or communication methods for wired communication (e.g., Ethernet, Power Line Communication (PLC), Home PNA, and IEEE 1394). The wireless communication module transmits and receives a wireless signal to and from at least one of a base station, an access point, and a repeater via a wireless communication network established according to technical standards or communication methods for wireless communication (e.g., wireless LAN (WLAN), wireless fidelity (Wi-Fi), Digital Living Network Alliance (DLNA), global system for mobile communication (GSM), code-division multiple access (CDMA), wideband CDMA (WCDMA), Long Term Evolution (LTE), 5G, and 6G).

The input unit 220 may include a camera for inputting an image signal, a microphone for inputting an audio signal, and a user input unit (e.g., a keyboard, a mouse, a touch key, and a mechanical key) for receiving information from a user. Data obtained via the input unit 220 may be analyzed and processed as a control command of the user.

The output unit 230 displays (outputs) information processed in the user terminal 200. In this embodiment, the output unit 230 may display execution screen information of a video communication application running on the user terminal 200, or user interface (UI) information or graphic user interface (GUI) information according to the execution screen information.

The network quality measurement unit 240 may measure loss data and delay data about a communication channel between the user terminal 200 and a video communication server 100. The network quality measurement unit 240 may measure the loss data and the delay data by using sequence number information and send time information.

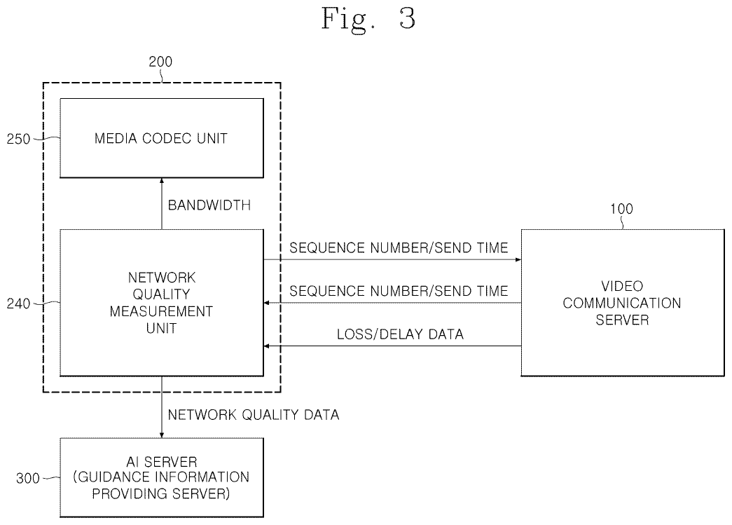

For example, as illustrated in FIG. 3, when transmitting a packet, the user terminal 200 may transmit sequence number information and send time information to the video communication server 100. Similarly, when transmitting a packet, the video communication server 100 may transmit sequence number information and send time information to the user terminal 200.

The network quality measurement unit 240 may measure loss data, based on the total number of packets received in a specific time interval, the sequence number of a packet initially received, and the sequence number of a packet last received. The video communication server 100 may also measure loss data in the same manner. The loss data measured by the user terminal 200 may be used as downlink loss data, and the loss data measured by the video communication server 100 may be used as uplink loss data.

The network quality measurement unit 240 may measure delay data, based on the send time of a packet and the arrival time of the packet. The video communication server 100 may also measure delay data in the same manner. The delay data measured by the user terminal 200 may be used as downlink delay data, and the delay data measured by the video communication server 100 may be used as uplink delay data.

The network quality measurement unit 240 may receive uplink loss data and uplink delay data from the video communication server 100.

The network quality measurement unit 240 may provide network quality data to the AI server 300. The network quality data may include downlink loss data, downlink delay data, uplink loss data, uplink delay data, and a network error code. The network quality data may be used to determine whether video communication quality deteriorates.

The network quality measurement unit 240 may determine a bandwidth available in a network, based on loss data and delay data. The network quality measurement unit 240 may provide information about the determined bandwidth to the media codec unit 250.

The media codec unit 250 may encode media data to be transmitted to another user terminal, or may decode media data received from another user terminal.

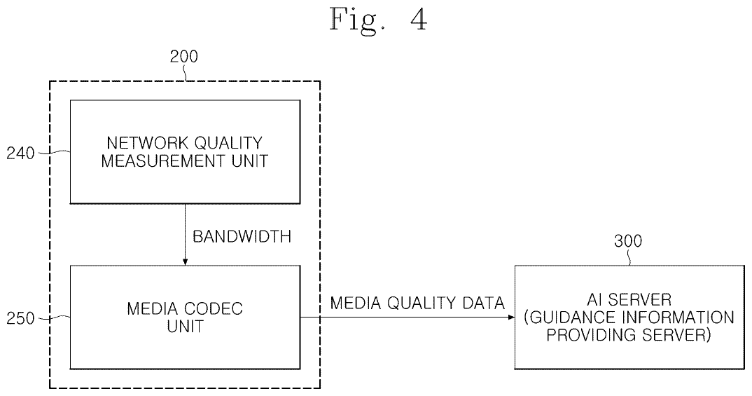

The media codec unit 250 may measure the quality of media data transmitted and received between the user terminal 200 and the video communication server 100. For example, as illustrated in FIG. 4, the media codec unit 250 may determine a playable video layer, based on bandwidth information received from the network quality measurement unit 240. Information about the video layer may be used as an indicator showing the quality of media data.

The media codec unit 250 may provide media quality data including video layer information to the AI server 300. The media quality data may be used together with network quality data to determine whether video communication quality deteriorates.

The prompt generation unit 260 may generate a prompt to be input into a generative AI model when a video communication quality deterioration event occurs due to network instability or the like.

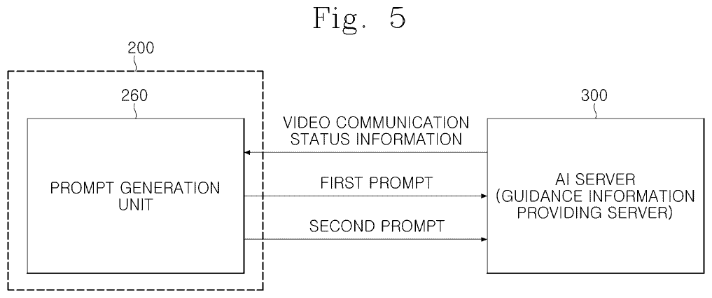

For example, as illustrated in FIG. 5, the prompt generation unit 260 may determine whether to generate a prompt, based on information about whether video communication quality received from the AI server 300 deteriorates (hereinafter, referred to as “video communication status information”). That is, when a network between the user terminal 200 and the video communication server 100 is unstable and video communication quality deteriorates, the prompt generation unit 260 may generate a prompt to be input into the generative AI model. When the video communication quality is normal, the prompt generation unit 260 does not generate a prompt to be input into the generative AI model.

The prompt generation unit 260 may generate a first prompt for generating action guidance information to be transmitted to a transmitting terminal. The first prompt may include at least one of device information (e.g., OS information, CPU information, and network information) about the transmitting terminal, network quality data, video communication status information, and a predefined system prompt. The video communication status information may include network status information.

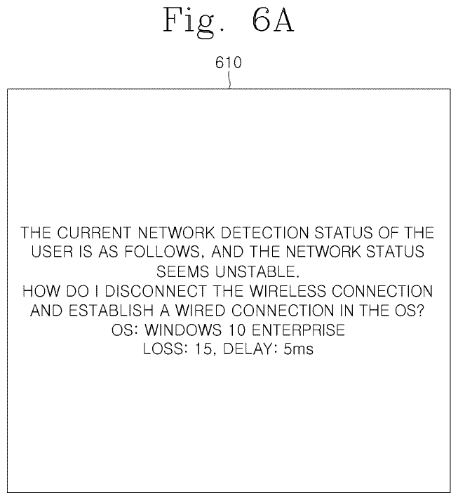

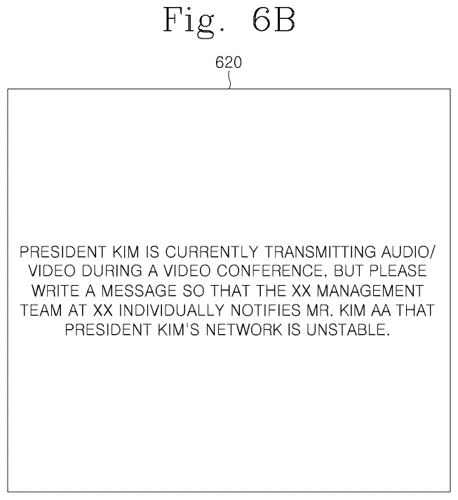

For example, as illustrated in FIG. 6A, the prompt generation unit 260 may generate the first prompt 610 by combining loss data, delay data, video communication status information, OS information about a transmitting terminal, and a predefined system prompt.

The prompt generation unit 260 may generate a second prompt for generating situation guidance information to be transmitted to one or more receiving terminals. The second prompt may include at least one of attendee information, guidance language information, and a predefined system prompt. The attendee information may include information about a transmitter transmitting media data and information about a receiver receiving the media data.

For example, as illustrated in FIG. 6B, the prompt generation unit 260 may generate the second prompt 620 by combining information about a transmitter transmitting media data, information about a receiver to which situation guidance information is transmitted, and a predefined system prompt.

The memory 270 stores data supporting various functions of the user terminal 200. In this embodiment, the memory 270 may store the video communication application running on the user terminal 200, and data and instructions for the operation of the user terminal 200.

The control unit 280 controls an operation related to the video communication application stored in the memory 270 and, generally, the overall operation of the user terminal 200. Furthermore, the control unit 280 may control at least one of the foregoing components in combination to implement various embodiments to be described below on the user terminal 200 according to the present disclosure.

Although this embodiment shows that the prompt generation unit 260 is configured in the user terminal 200, which is not necessarily limited thereto, it will be obvious to those skilled in the art that the prompt generation unit 260 may be configured in the AI server 300. In this case, a prompt acquisition unit 340 in the AI server 300 may be replaced with the prompt generation unit 260.

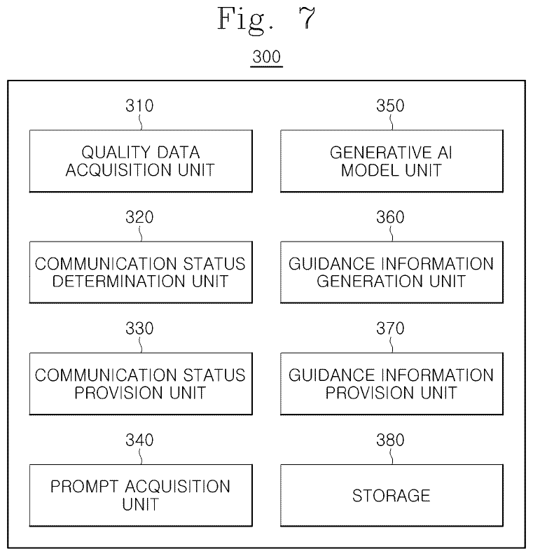

FIG. 7 is a block diagram illustrating the configuration of an AI server according to an embodiment of the present disclosure.

Referring to FIG. 7, the AI server 300 according to the embodiment of the present disclosure may include a quality data acquisition unit 310, a communication status determination unit 320, a communication status provision unit 330, a prompt acquisition unit 340, a generative AI model unit 350, a guidance information generation unit 360, a guidance information provision unit 370, and a storage 380. The components illustrated in FIG. 7 are not essential to configure the AI server 300, and thus the AI server 300 described herein may have more or fewer components than the components listed above.

The quality data acquisition unit 310 may obtain network quality data from a network quality measurement unit 240 of a user terminal 200. The network quality data may include downlink loss data, downlink delay data, uplink loss data, uplink delay data, and a network error code.

The quality data acquisition unit 310 may obtain media quality data from a media codec unit 250 of the user terminal 200. The media quality data may include video layer information.

The communication status determination unit 320 may determine whether video communication quality deteriorates, based on at least one of network quality data and media quality data. The communication status determination unit 320 may determine whether the video communication quality deteriorates by using a pre-trained deep learning model. In another embodiment, the communication status determination unit 320 may determine whether the video communication quality deteriorates by using a preset reference value.

The communication status provision unit 330 may provide information about whether video communication quality deteriorates (i.e., video communication status information) to the user terminal 200. The user terminal 200 may provide the received information to a prompt generation unit 260.

The prompt acquisition unit 340 may obtain, from the user terminal 200, a first prompt for generating action guidance information to be transmitted to a transmitting terminal. The first prompt may include at least one of device information (e.g., OS information, CPU information, and network information) about the transmitting terminal, network quality data, video communication status information, and a predefined system prompt.

The prompt acquisition unit 340 may obtain, from the user terminal 200, a second prompt for generating situation guidance information to be transmitted to one or more receiving terminals. The second prompt may include at least one of attendee information, guidance language information, and a predefined system prompt.

The generative AI model unit 350 may include a pre-established generative AI model. The generative AI model may generate text and/or an image, based on an input prompt. The generative AI model a type of large language model (LLM), and may employ Chat-GPT or Bard but is not necessarily limited thereto.

The guidance information generation unit 360 may generate action guidance information, based on the first prompt, by using the generative AI model. The action guidance information may include information indicating a method for solving deterioration in video communication quality to the transmitting terminal.

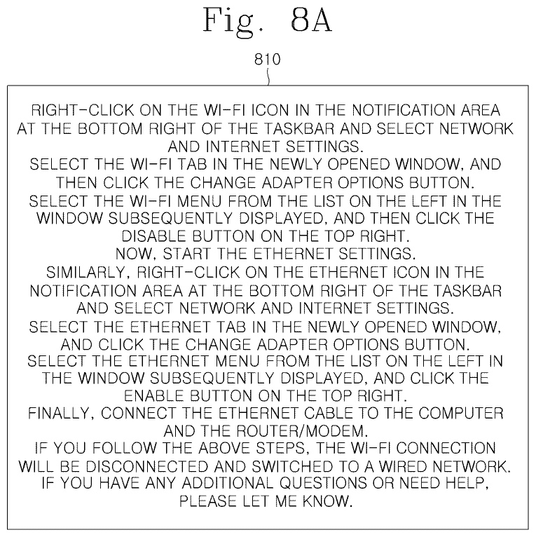

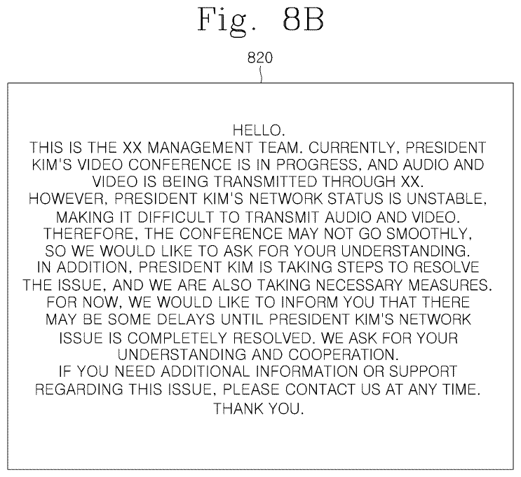

For example, as illustrated in FIG. 8A, the guidance information generation unit 360 may generate action guidance information 810 including a method of changing a user's network environment from wireless to wired.

The guidance information generation unit 360 may generate situation guidance information, based on the second prompt, by using the generative AI model. The situation guidance information may include information indicating to the receiving terminals that a video communication quality deterioration event has occurred in the transmitting terminal.

For example, as illustrated in FIG. 8B, the guidance information generation unit 360 may generate situation guidance information 820 including information indicating that a video communication quality deterioration event has occurred in the transmitting terminal, information indicating that a transmitter is making an effort to resolve the video communication quality deterioration, and information for requesting cooperation of a receiver.

The guidance information provision unit 370 may provide generated action guidance information to the transmitting terminal.

The guidance information provision unit 370 may provide generated situation guidance information to the one or more receiving terminals. The guidance information provision unit 370 may provide the situation guidance information to the one or more receiving terminals through the video communication server 100.

The storage 380 may store data necessary to provide guidance information related to the communication status of a video communication service. For example, the storage 380 may include network quality data, media quality data, video communication status information, first prompt data, second prompt data, action guidance information, and situation guidance information.

Although this embodiment shows that the generative AI model is established within the AI server 300, which is not necessarily limited thereto, and it will be obvious to those skilled in the art that the generative AI model may be established independently outside the AI server 300.

As described above, when a video communication quality deterioration event occurs due to network instability or the like, the AI server 300 according to the embodiment of the present disclosure generates action guidance information, based on the generative AI model, and provides the generated action guidance information to a transmitting terminal, thereby allowing the transmitter to recognize that the situation is resolvable and to immediately resolve deterioration in video communication quality. In addition, when the video communication quality deterioration event occurs due to network instability or the like, the AI server 300 generates situation guidance information, based on the generative AI model, and provides the generated situation guidance information to one or more receiving terminals, thereby preventing the receivers from taking unnecessary actions and allowing the receivers to concentrate on real-time video communication.

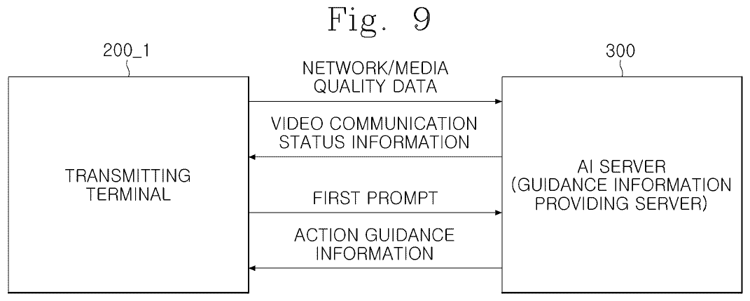

FIG. 9 illustrates a method referenced to explain a method in which an AI server generates action guidance information and provides the action guidance information to a transmitting terminal. As illustrated in FIG. 9, the AI server 300 may obtain network quality data and media quality data from the transmitting terminal 200_1. The AI server 300 may determine whether video communication quality deteriorates, based on at least one of the obtained network quality data and media quality data. The AI server 300 may provide information about whether the video communication quality deteriorates (i.e., video communication status information) to the transmitting terminal 200_1. Subsequently, the AI server 300 may generate action guidance information, based on a first prompt received from the transmitting terminal 200_1, and may provide the generated action guidance information to the transmitting terminal 200_1.

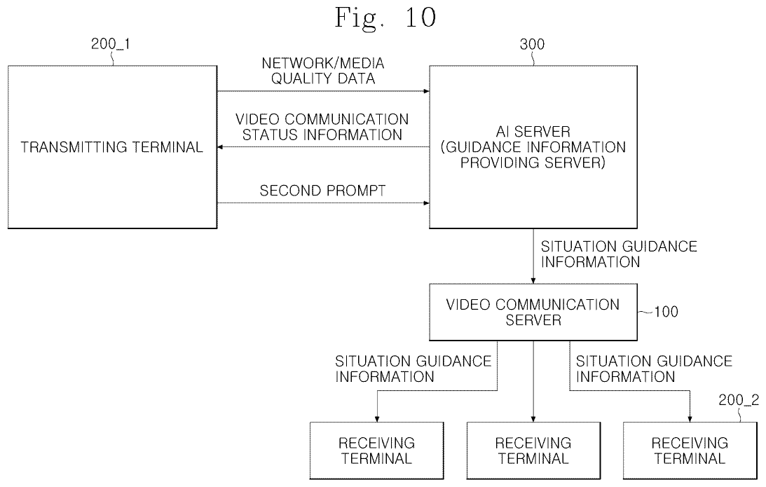

FIG. 10 illustrates a method referenced to explain a method in which an AI server generates situation guidance information and provides the situation guidance information to a receiving terminal. As illustrated in FIG. 10, the AI server 300 may obtain network quality data and media quality data from a transmitting terminal 200_1. The AI server 300 may determine whether video communication quality deteriorates, based on at least one of the obtained network quality data and media quality data. The AI server 300 may provide information about whether the video communication quality deteriorates (i.e., video communication status information) to the transmitting terminal 200_1. Subsequently, the AI server 300 may generate situation guidance information, based on a second prompt received from the transmitting terminal 200_1, and may transmit the generated situation guidance information to a video communication server 100. The video communication server 100 may transmit the received situation guidance information to one or more receiving terminals 200_2.

Although this embodiment shows that the transmitting terminal directly communicates with the AI server 300, which is not necessarily limited thereto, it will be obvious to those skilled in the art that the transmitting terminal may communicate with the AI server 300 through the video communication server 100.

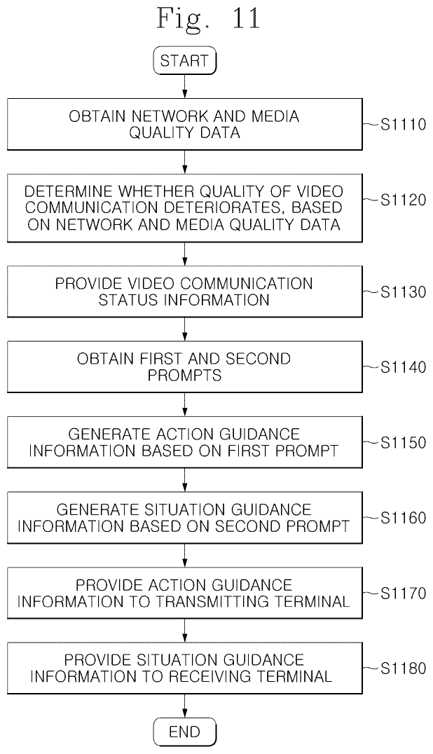

FIG. 11 is a flowchart illustrating a guidance information providing method according to an embodiment of the present disclosure. The guidance information providing method according to the embodiment may be performed by an AI server 300. Although the illustrated flowchart shows that the guidance information providing method is divided into a plurality of operations, at least some of the operations may be performed in a different order, be performed in combination with other operations, be omitted, or be performed as being divided into detailed operations, or one or more operations not shown may be additionally performed.

Referring to FIG. 11, the AI server 300 according to the present disclosure may obtain at least one of network quality data and media quality data from a transmitting terminal (S1110).

The AI server 300 may determine whether video communication quality deteriorates, based on at least one of the network quality data and the media quality data obtained from the transmitting terminal (S1120). Here, the AI server 300 may determine whether the video communication quality deteriorates by using a pre-trained deep learning model.

The AI server 300 may provide information about whether the video communication quality deteriorates (i.e., video communication status information) to the transmitting terminal (S1130).

The AI server 300 may obtain a first prompt for generating action guidance information and a second prompt for generating situation guidance information from the transmitting terminal (S1140).

The AI server 300 may generate action guidance information, based on the first prompt, by using an LLM model (S1150). The action guidance information may include information indicating a method for solving deterioration in video communication quality to the transmitting terminal.

In another embodiment, the AI server 300 may generate action guidance information by using an LLM model based on retrieval-augmented generation (RAG).

The AI server 300 may generate situation guidance information, based on the second prompt, by using the LLM model (S1160). The situation guidance information may include information indicating to a receiving terminal that a video communication quality deterioration event has occurred in the transmitting terminal.

In another embodiment, the AI server 300 may generate situation guidance information by using the LLM model based on retrieval-augmented generation (RAG).

The AI server 300 may provide the generated action guidance information to the transmitting terminal (S1170).

The AI server 300 may provide the generated situation guidance information to one or more receiving terminals (S1180). Here, the AI server 300 may provide the situation guidance information to the one or more receiving terminals through a video communication server 100.

As described above, when a video communication quality deterioration event occurs due to network instability or the like, the guidance information providing method according to the embodiment of the present disclosure generates action guidance information, based on the generative AI model, and provides the generated action guidance information to a transmitting terminal, thereby allowing the transmitter to recognize that the situation is resolvable and to immediately resolve deterioration in video communication quality. In addition, when the video communication quality deterioration event occurs due to network instability or the like, the guidance information providing method generates situation guidance information, based on the generative AI model, and provides the generated situation guidance information to one or more receiving terminals, thereby preventing the receivers from taking unnecessary actions and allowing the receivers to concentrate on real-time video communication.

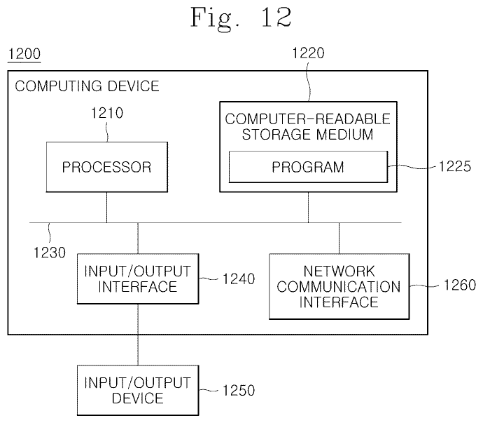

FIG. 12 is a block diagram illustrating the configuration of a computing device according to an embodiment of the present disclosure.

Referring to FIG. 12, the computing device 1200 according to the embodiment of the present disclosure may include at least one processor 1210, a computer-readable storage medium 1220, and a communication bus 1230. The computing device 1200 may be realized as the user terminal 200 described above or be realized as the components 210 to 280 included in the user terminal 200. In addition, the computing device 1200 may be realized as implement the AI server 300 described above or be realized as the components 310 to 380 included in the AI server 300.

The processor 1210 may cause the computing device 1200 to operate according to the foregoing illustrative embodiments. For example, the processor 1210 may execute at least one program 1225 stored in the computer-readable storage medium 1220. The at least one program may include at least one computer-executable instruction, and the computer-executable instruction may be configured to cause the computing device 1200 to perform operations according to the illustrative embodiments when executed by the processor 1210.

The computer-readable storage medium 1220 is configured to store a computer-executable instruction or program code, program data, and/or other suitable forms of information. The program 1225 stored in the computer-readable storage medium 1220 includes a set of instructions executable by the processor 1210. In an embodiment, the computer-readable storage medium 1220 may be a memory (a volatile memory such as a random access memory, a nonvolatile memory, or a suitable combination thereof), one or more magnetic disk storage devices, optical disk storage devices, flash memory devices, or other forms of storage medium that are accessed by the computing device 1200 and are capable of storing desired information, or a suitable combination thereof.

The communication bus 1230 interconnects various other components of the computing device 1200 including the processor 1210 and the computer-readable storage medium 1220.

The computing device 1200 may also include at least one input/output interface 1240 that provides an interface for at least one input/output device 1250 and at least one network communication interface 1260. The input/output interface 1240 and the network communication interface 1260 are connected to the communication bus 1230.

The input/output device 1250 may be connected to other components of the computing device 1200 via the input/output interface 1240. The illustrative input/output device 1250 may include an input device, such as a pointing device (mouse or Trackpad), a keyboard, a touch input device (touchpad or touchscreen), a voice or sound input device, various types of sensor devices, and/or a photographing device, and/or an output device, such as a display device, a printer, a speaker, and/or a network card. The illustrative input/output device 1250 may be included in the computing device 1200 as a component of the computing device 1200, or may be connected to the computing device 1200 as a separate device distinct from the computing device 1200.

Effects of a method for providing a video communication service by using generative AI and an apparatus therefor according to embodiments of the present disclosure are described as follows.

According to at least one of the embodiments of the present disclosure, when a video communication quality deterioration event occurs due to network instability or the like, it is possible to generate action guidance information, based on the generative AI model and provide the generated action guidance information to a transmitting terminal, thereby allowing the transmitter to recognize that the situation is resolvable and to immediately resolve deterioration in video communication quality.

In addition, according to at least one of the embodiments of the present disclosure, when the video communication quality deterioration event occurs due to network instability or the like, it is possible to generate situation guidance information, based on the generative AI model and provide the generated situation guidance information to one or more receiving terminals, thereby preventing the receivers from taking unnecessary actions and allowing the receivers to concentrate on real-time video communication.

Effects obtainable by a method for providing a video communication service by using generative AI and an apparatus therefor according to embodiments of the present disclosure are not limited to the effects mentioned above, and other effects not mentioned will be clearly understood by those skilled in the art from the following description.

The disclosure described above can be realized as a computer-readable code in a medium recording a program. A computer-readable medium may keep storing a computer-executable program or may temporarily store the computer-executable program for execution or download. Further, the medium may include various recording devices or storage devices in a form in which a single piece or a plurality of pieces of hardware is combined and may be distributed on a network without being limited to a medium directly connected to a computer system. Examples of the medium may include those configured to store a program instruction including a magnetic medium, such as a hard disk, a floppy disk, and a magnetic tape, an optical recording medium, such as a CD-ROM and a DVD, a magneto-optical medium, such as a floptical disk, a ROM, a RAM, a flash memory, and the like. In addition, other examples of the medium may include an app store that distributes applications, a site that supplies or distributes various types of software, and a recording medium or a storage medium managed by a server. Therefore, the above detailed description should not be construed as restrictive in all aspects and should be considered as illustrative. The scope of the disclosure should be determined based on reasonable interpretation of the appended claims, and all changes and modifications within the equivalent scope of the disclosure are included in the scope of the disclosure.

What is claimed is:

1. A guidance information providing method performed by a computing device, the guidance information providing method comprising:
obtaining at least one of network quality data and media quality data related to video communication;
determining whether quality of the video communication deteriorates, based on the obtained at least one of the network quality data and the media quality data; and
generating first guidance information for solving a deterioration in the quality of the video communication, based on a first prompt using a generative AI model when the quality of the video communication deteriorates.

2. The guidance information providing method of claim 1, further comprising:
providing information about whether the quality of the video communication deteriorates to a transmitting terminal; and
obtaining the first prompt from the transmitting terminal.

3. The guidance information providing method of claim 2, wherein the first prompt comprises at least one of device information about the transmitting terminal, the network quality data, the information about whether the quality of the video communication deteriorates, and a predefined system prompt.

4. The guidance information providing method of claim 1, wherein
the network quality data comprises at least one of loss data, delay data, and a network error code, and
the media quality data comprises video layer information.

5. The guidance information providing method of claim 1, wherein the determining comprises determining whether the quality of the video communication deteriorates using a pre-trained deep learning model.

6. The guidance information providing method of claim 1, further comprising
providing the generated first guidance information to a transmitting terminal.

7. The guidance information providing method of claim 1, further comprising
generating second guidance information for sharing the deterioration in the quality of the video communication, based on a second prompt using the generative AI model when the quality of the video communication deteriorates.

8. The guidance information providing method of claim 7, further comprising:
providing the information about whether the quality of the video communication to a transmitting terminal; and
obtaining the second prompt from the transmitting terminal.

9. The guidance information providing method of claim 7, wherein the second prompt comprises at least one of attendee information, guidance language information, and a predefined system prompt.

10. The guidance information providing method of claim 7, further comprising
providing the generated second guidance information to one or more receiving terminals.

11. The guidance information providing method of claim 1, wherein the generating comprises generating the first guidance information using a large language model (LLM) based on retrieval-augmented generation (RAG).

12. A guidance information providing server comprising at least one processor configured to execute a plurality of instructions to perform a plurality of operations and at least one memory configured to store the plurality of instructions,
wherein the plurality of operations comprises:
obtaining at least one of network quality data and media quality data related to video communication;
determining whether quality of the video communication deteriorates, based on the obtained at least one of the network quality data and the media quality data; and
generating first guidance information for solving a deterioration in the quality of the video communication, based on a first prompt using a generative AI model when the quality of the video communication deteriorates.

13. The guidance information providing server of claim 12, wherein the plurality of operations further comprises:
providing information about whether the quality of the video communication deteriorates to a transmitting terminal; and
obtaining the first prompt from the transmitting terminal.

14. The guidance information providing server of claim 13, wherein the first prompt comprises at least one of device information about the transmitting terminal, the network quality data, the information about whether the quality of the video communication deteriorates, and a predefined system prompt.

15. The guidance information providing server of claim 12, wherein
the network quality data comprises at least one of loss data, delay data, and a network error code, and
the media quality data comprises video layer information.

16. The guidance information providing server of claim 12, wherein the plurality of operations further comprises providing the generated first guidance information to a transmitting terminal.

17. The guidance information providing server of claim 12, wherein the plurality of operations further comprises generating second guidance information for sharing the deterioration in the quality of the video communication, based on a second prompt using the generative AI model when the quality of the video communication deteriorates.

18. The guidance information providing server of claim 17, wherein the second prompt comprises at least one of attendee information, guidance language information, and a predefined system prompt.

19. The guidance information providing server of claim 17, wherein the plurality of operations further comprises providing the generated second guidance information to one or more receiving terminals.

20. A computer-readable storage medium storing one or more programs for execution by one or more processors of a computing device, the one or more programs comprising instructions to:
obtain at least one of network quality data and media quality data related to video communication;
determine whether quality of the video communication deteriorates, based on the obtained at least one of the network quality data and the media quality data; and
generate first guidance information for solving a deterioration in the quality of the video communication, based on a first prompt using a generative AI model when the quality of the video communication deteriorates.
